(19) United States
(12) Patent Application Publication
(10) Pub. No.: US 2009/0150482 A1
(43) Pub. Date: Jun. 11, 2009

(54) Method of cloning a server installation to a network client

(75) Inventors: David Bradley Markisohn, Indianapolis, IN (US); Raul G. Lara, Indianapolis, IN (US)

Correspondence Address: BAKER & DANIELS LLP / ROCHE, 300 NORTH MERIDIAN STREET, SUITE 2700, INDIANAPOLIS, IN, 46204, US

(73) Assignee: Roche Diagnostics Operations, Inc., Indianapolis, IN (US)

(21) Appl. No.: 11/999,876

(22) Filed: Dec. 7, 2007

(51) Int. Cl. G06F 15/16

(52) U.S. Cl. 709/203

(57) ABSTRACT

A medical data system wherein a server installation identifies configuration choices and creates a client installer that will install a cloned application on client machines that conforms to the configuration choices made during the server installation.

### FIELD OF THE INVENTION

The present disclosure relates to a method and system for installing networked software. More particularly, the disclosure relates a method and system for cloning a client installation from a network server installation.

### BACKGROUND OF THE INVENTION

Many fields of medical treatment and healthcare require monitoring of certain body functions, physical states and conditions, and patient behaviors. Thus, e.g., for patients suffering from diabetes, a regular check of the blood glucose level forms an essential part of the daily routine. The blood glucose level has to be determined quickly and reliably, often several times per day. Medical devices are used to facilitate the collection of medical information without unduly disturbing the lifestyle of the patient. A large number of medical devices for monitoring various body functions are commercially available. Also, medical treatment and healthcare may require monitoring of exercise, diet, meal times, stress, work schedules and other activities and behaviors.

Applications are provided to manage data received from medical devices on medical information systems. The medical information systems often exist in a network of computers having server and client computers having applications thereon. Installation of client applications and server applications may involve selection of choices that impact settings, features, associations, and other variables that impact operation of the applications. In some network/client installations of application, consistent and uniform operation on one or more of the installations is desired. Such consistent and uniform operation may be achieved by making identical selections during installation at each system. However, some installations require custom designation of associations, such as selection of a database on a connected server, that require custom text input rather than a selection of a provided option.

All systems are not necessarily set up at the same time, especially for systems that are added for expansion. Accordingly, subsequent system installations may be performed by different personnel or by personnel who are unaware of the settings on the other networked systems. This gap in time and knowledge can make it difficult to achieve a consistent installation across systems in which a consistent installation is desired.

### SUMMARY OF THE INVENTION

The disclosure relates to a method and system for interfacing between a healthcare management system and medical devices. One embodiment of the system includes a computer readable medium including first instructions thereon. When the first instructions are interpreted by a processor, the processor performs the steps of: installing an application on a server computer; the installing step including allowing for configuration choices to be made by a user regarding the application; copying at least some of the first instructions to the server computer to create a set of second instructions; and adding data to the set of second instructions that indicates the configuration choices made during the step of installing an application on a server computer. The set of second instructions, when interpreted by a processor, causes the processor to perform the step of: installing the application on a client computer such that the application being installed on the client computer is configured according to the added data.

In some embodiments, a computer readable medium including first instructions thereon is provided. The first instructions cause the processor to perform the steps of: installing a server health data application on a server computer; the installing step including requesting input from a user to configure the server health data application; copying at least some of the first instructions to the server computer to create a set of second instructions; and modifying the set of second instructions to identify configuration choices made during the step of installing the server health data application. The set of second instructions, when interpreted by a processor cause the processor to perform the step of: installing a client health data application on a client computer such that the client health data application is configured according to installation choices made during the step of installing a server health data application.

In another embodiment, a method of installing a client application is provided including the steps of: installing an application on a server computer including configuring the application; copying an installer program to the server computer to create a replicated installer program; incorporating configuration information regarding the configuration of the application installed on the server into the replicated installer program; and executing the replicated installer program to create a client computer installation of the application that is configured according to the configuration information.

### DESCRIPTION OF THE DRAWINGS

For more complete understanding of the present disclosure, reference is established to the following drawings in which:

FIG. 1 shows an embodiment of a health management system comprising server and client systems; and

FIG. 2 is a first block diagram of a software installation on the server system of FIG. 1.

Corresponding reference characters indicate corresponding parts throughout the several views. Although the drawings represent embodiments of various features and components according to the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

For the purposes of promoting an understanding of the principles of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the invention is thereby intended. The disclosure includes any alterations and further modifications in the illustrated devices and described methods and further applications of the principles of the disclosure which would normally occur to one skilled in the art to which the disclosure relates.

The terms “network,” “local area network,” “LAN,” “wide area network,” or “WAN” mean two or more computers which are connected in such a manner that messages may be transmitted between the computers. In such computer networks, typically one or more computers operate as a “server,” a computer with large storage devices such as hard disk drives and communication hardware to operate peripheral devices such as printers or modems. Other computers, termed “clients” or “workstations,” provide a user interface so that users of computer networks can access the network resources, such as shared data files, common peripheral devices, and inter-workstation communication. The computers have at least one processor for executing machine instructions, and memory for storing instructions and other information. Many combinations of processing circuitry and information storing equipment are known by those of ordinary skill in these arts. A processor may be a microprocessor, a digital signal processor (“DSP”), a central processing unit (“CPU”), or other circuit or equivalent capable of interpreting instructions or performing logical actions on information. Memory includes both volatile and non-volatile memory, including temporary and cache, in electronic, magnetic, optical, printed, or other format used to store information. Users activate computer programs or network resources to create “processes” which include both the general operation of the computer program along with specific operating characteristics determined by input variables and its environment.

Concepts described below may be further explained in one of more of the co-filed patent applications entitled HELP UTILITY FUNCTIONALITY AND ARCHITECTURE (Atty Docket: ROCHE-P0033), METHOD AND SYSTEM FOR GRAPHICALLY INDICATING MULTIPLE DATA VALUES (Atty Docket: ROCHE-P0039), SYSTEM AND METHOD FOR DATABASE INTEGRITY CHECKING (Atty Docket: ROCHE-P0056), METHOD AND SYSTEM FOR DATA SOURCE AND MODIFICATION TRACKING (Atty Docket: ROCHE-P0037), PATIENT-CENTRIC HEALTHCARE INFORMATION MAINTENANCE (Atty Docket: ROCHE-P0043), EXPORT FILE FORMAT WITH MANIFEST FOR ENHANCED DATA TRANSFER (Atty Docket: ROCHE-P0044), GRAPHIC ZOOM FUNCTIONALITY FOR A CUSTOM REPORT (Atty Docket: ROCHE-P0048), METHOD AND SYSTEM FOR SELECTIVE MERGING OF PATIENT DATA (Atty Docket: ROCHE-P0065), METHOD AND SYSTEM FOR PERSONAL MEDICAL DATA DATABASE MERGING (Atty Docket: ROCHE-P0066), METHOD AND SYSTEM FOR WIRELESS DEVICE COMMUNICATION (Atty Docket: ROCHE-P0034), METHOD AND SYSTEM FOR SETTING TIME BLOCKS (Atty Docket: ROCHE-P0054), METHOD AND SYSTEM FOR ENHANCED DATA TRANSFER (Atty Docket: ROCHE-P0042), COMMON EXTENSIBLE DATA EXCHANGE FORMAT (Atty Docket: ROCHE-P0036), METHOD AND SYSTEM FOR QUERYING A DATABASE (Atty Docket: ROCHE-P0049), METHOD AND SYSTEM FOR EVENT BASED DATA COMPARISON (Atty Docket: ROCHE-P0050), DYNAMIC COMMUNICATION STACK (Atty Docket: ROCHE-P0051), SYSTEM AND METHOD FOR REPORTING MEDICAL INFORMATION (Atty Docket: ROCHE-P0045), METHOD AND SYSTEM FOR MERGING EXTENSIBLE DATA INTO A DATABASE USING GLOBALLY UNIQUE IDENTIFIERS (Atty Docket: ROCHE-P0052), METHOD AND SYSTEM FOR ACTIVATING FEATURES AND FUNCTIONS OF A CONSOLIDATED SOFTWARE APPLICATION (Atty Docket: ROCHE-P0057), METHOD AND SYSTEM FOR CONFIGURING A CONSOLIDATED SOFTWARE APPLICATION (Atty Docket: ROCHE-P0058), METHOD AND SYSTEM FOR DATA SELECTION AND DISPLAY (Atty Docket: ROCHE-P0011), METHOD AND SYSTEM FOR ASSOCIATING DATABASE CONTENT FOR SECURITY ENHANCEMENT (Atty Docket: ROCHE-P0041), METHOD AND SYSTEM FOR CREATING REPORTS (Atty Docket: ROCHE-P0046), METHOD AND SYSTEM FOR CREATING USER-DEFINED OUTPUTS (Atty Docket: ROCHE-P0047), DATA DRIVEN COMMUNICATION PROTOCOL GRAMMAR (Atty Docket: ROCHE-P0055), HEALTHCARE MANAGEMENT SYSTEM HAVING IMPROVED PRINTING OF DISPLAY SCREEN INFORMATION (Atty Docket: ROCHE-P0031), and METHOD AND SYSTEM FOR MULTI-DEVICE COMMUNICATION (Atty Docket: ROCHE-P0064), the entire disclosures of which are hereby expressly incorporated herein by reference. It should be understood that the concepts described below may relate to diabetes management software systems for tracking and analyzing health data, such as, for example, the Accu-Chek® 360∘ product provided by Roche Diagnostics. However, the concepts described herein may also have applicability to apparatuses, methods, systems, and software in fields that are unrelated to healthcare. Furthermore, it should be understood that references in this patent application to devices, meters, monitors, pumps, or related terms are intended to encompass any currently existing or later developed apparatus that includes some or all of the features attributed to the referred to apparatus, including but not limited to the Accu-Chek® Active, Accu-Chek® Aviva, Accu-Chek® Compact, Accu-Chek® Compact Plus, Accu-Chek® Integra, Accu-Chek® Go, Accu-Chek® Performa, Accu-Chek® Spirit, Accu-Chek® D-Tron Plus, and Accu-Chek® Voicemate Plus, all provided by Roche Diagnostics or divisions thereof.

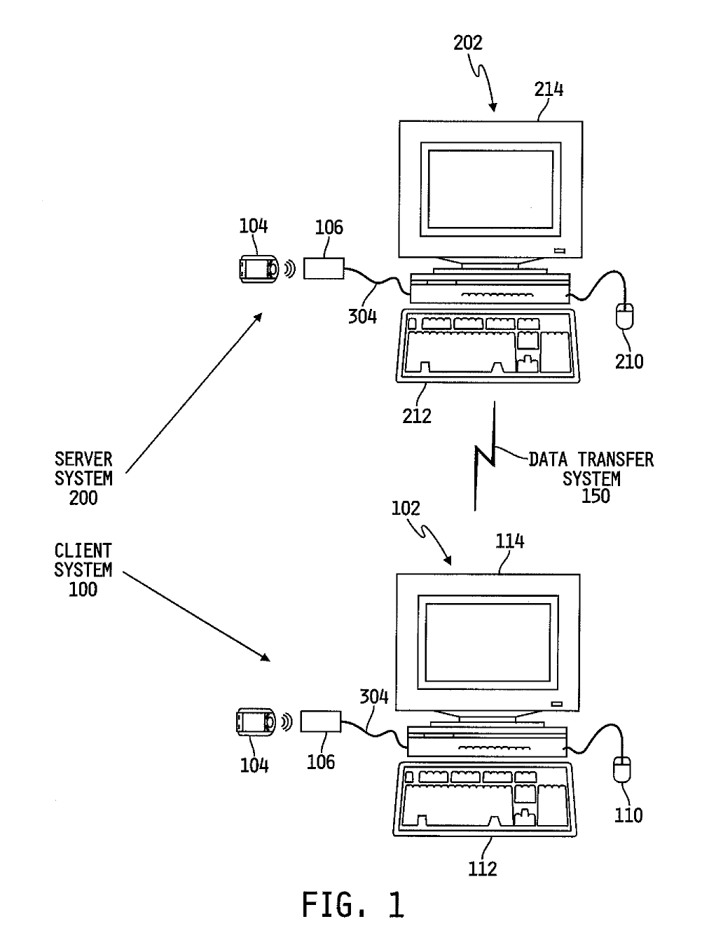

Turning now to the figures, FIG. 1 depicts an exemplary embodiment of client system 100 and server system 200 connected via a WAN 150 for monitoring data. Systems 100, 200 each comprise a computing device, shown here in the form of computers 102, 202 having processing units, system memory, display devices 114, 214, and input devices 112, 212, 110, 210, 106. Furthermore, while only one client system 100 and computer 102 are shown, many more client computers 102 may be part of the overall system. Similarly, multiple servers 202 may be employed.

While standard input devices such as mice 110, 210 and keyboards 112, 212 are shown, systems 100, 200 may comprise any user input device. By example, infrared (IR) dongle 106 is coupled to each of computers 102, 202. Some embodiments of servers 200 are envisioned without direct standard input devices. IR dongle 106 is configured to send and receive IR transmissions from health management device 104. Computers 102, 202 include software applications 300 configured to receive data from health management device 104 via IR dongle 106 or otherwise. Installations of software applications 300 may differ depending on many factors including e.g., geography, users, and client/server distinctions.

While the use of IR and IR dongles is disclosed herein for the transmission of data between health management device 104 and computers 102, 202, any other method of transmission is also envisioned, including but not limited to RF, Bluetooth, and RS232. Systems 100, 200 include software applications 300, shown here as health management software, configured to receive medical information from one or more of input devices 112, 212, 110, 210, 106. Health management devices 104 are described herein as meters, but could also be a PDA, therapeutic pump, combinations thereof, or other devices that store medical data thereon. Medical information may include blood glucose values, Alc values, Albumin values, Albumin excretion values, body mass index values, blood pressure values, carbohydrate values, cholesterol values (total, HDL, LDL, ratio) creatinine values, fructosamine values, HbA1 values, height values, insulin dose values, insulin rate values, total daily insulin values, ketone values, microalbumin values, proteinuria values, heart rate values, temperature values, triglyceride values, weight values, and any other medical information that is desired to be known.

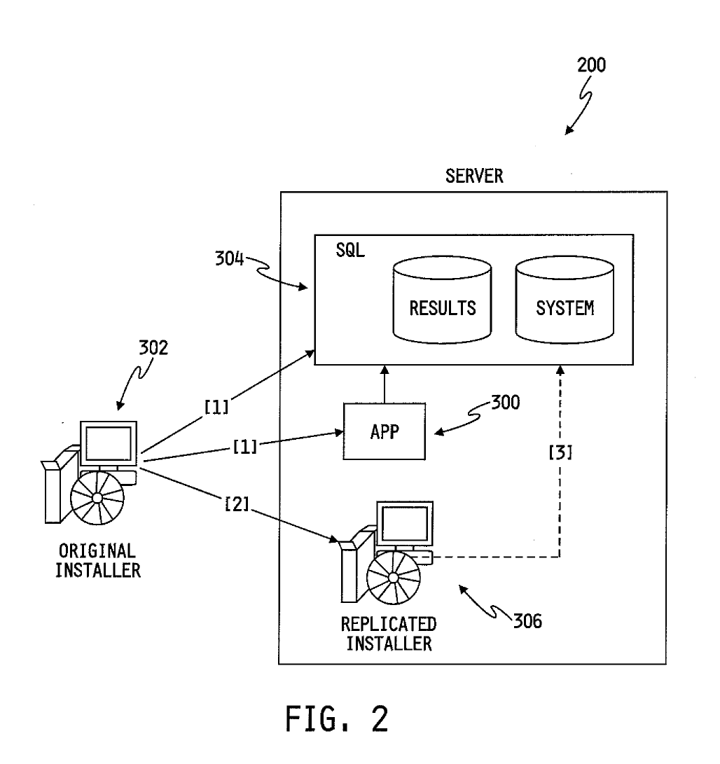

Installation of application 300 on server system 200 is shown in FIG. 2. Application 300 is provided on a computer readable medium such as, but not limited to, one or more CD-ROM's 302. CD-ROM 302 includes instructions thereon that cause the processor on which they are interpreted to perform a number of steps. Application 300 installs itself on server system 200, during step [1]. During the installation, selections are made such as providing an activation key, selection of a default language, selection of features, selection of a default database to be used by subsequent client installations, selection of available reporting languages, selection of geographic region, selection of an installation directory, and any other programmer designated variables and configuration choices. CD-ROM 302 also installs additional applications/programs needed by application 300, such as application and SQL server databases 304 in the present example, during step [1]. Additional applications/programs needed by application 300 include the Microsoft .NET Framework 2.0 and Borland Data Engine at the server.

In a second step [2], the original installer on CD-ROM 302 copies itself to an installation directory of server system 200, shown as replicated installer 306. Once present within server system 200, files that contain configuration data, for example initialization or INI files, are modified to activate a user interface flag that limits replicated installer 306 to only providing installations for client systems 100. The configuration data may also be altered to identify settings selected during the network installation of application 300. The settings can thereby be replicated to any subsequent application 300 installation to ensure feature similarity. Replicated installer 306 also sets server databases 304 as the default databases presented in an installation wizard used during execution of replicated installer 306, shown as step [3]. Replicated installer 306 is thus created and self-configured at server system 200. In the present embodiment, replicated installer 306 is configured to identify a default client results database name and location, a marketing group (localization data), a product class, and a feature set mask. Product class and feature set masks are used to identify differing levels of functionality that may be provided in differing product offerings, such as standard and professional versions with differing functionality. Product class and feature set mask are identified by reparsing an activation key that is used during the server application 300 installation. The activation key is described further in the previously incorporated co-filed applications.

Subsequent client 100 installations of application 300 are achieved by selecting replicated installer 306 on server system 200. This selection may be made via a shortcut pushed or pulled down to client system 100, by navigating to server system 200 over WAN 150, or otherwise. Installer 306 then executes a client install using the modified configuration data files to match up with the installation of application 300 on server system 200. Similarly, the client installation of application 300 defaults to and suggests the server databases 304 as the databases to be used. Accordingly, the user executing the client installation of application 300 is provided with the configuration data to achieve compatibility with the installation of application 300 on server system 200. Some selections made during the server installation are not changeable during client install such as activation key and System database. Other selections made during the server installation are provided as default values that are changeable during the client install such as the Results Database. Still other selections made during the server installation are not configured in the replicated installer and thus not reflected in the client installer such as installation directory and default language.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A computer readable medium, including first instructions thereon such that when interpreted by a processor cause the processor to perform the steps of:
installing an application on a server computer; the installing step including allowing for configuration choices to be made by a user regarding the application;
copying at least some of the first instructions to the server computer to create a set of second instructions; and
adding data to the set of second instructions that indicates the configuration choices made during the step of installing an application on a server computer; the set of second instructions, when interpreted by a processor, causes the processor to perform the step of:
installing the application on a client computer such that the application being installed on the client computer is configured according to the added data.

2. The computer readable medium of claim 1, wherein the installing step of installing an application on a server computer includes creating a database.

3. The computer readable medium of claim 2, wherein the step of adding data to the set of second instructions includes identifying the created database.

4. The computer readable medium of claim 1, wherein the step of installing an application on a server computer includes designating a database.

5. The computer readable medium of claim 1, wherein the configuring of the application includes parsing an activation code.

6. The computer readable medium of claim 1, wherein the step of installing an application on a server computer includes installing a health data monitoring application.

7. The computer readable medium of claim 1, wherein the step of installing an application on a client computer includes installing a health data monitoring application.

8. The computer readable medium of claim 1, wherein the application being installed on the client computer is configured to interface with a health management device.

9. The computer readable medium of claim 8, wherein the health management device includes a glucose measurement engine, and the application being installed on the client computer is configured to receive and store data from the health management device.

10. The computer readable medium of claim 1, wherein the first instructions further cause the processor to perform the step of modifying the set of second instructions such that the set of second instructions are only able to create client health data applications.

11. A computer readable medium, including first instructions thereon such that when interpreted by a processor cause the processor to perform the steps of:
installing a server health data application on a server computer; the installing step including requesting input from a user to configure the server health data application;
copying at least some of the first instructions to the server computer to create a set of second instructions; and
modifying the set of second instructions to identify configuration choices made during the step of installing the server health data application; the set of second instructions, when interpreted by a processor cause the processor to perform the step of:
installing a client health data application on a client computer such that the client health data application is configured according to installation choices made during the step of installing a server health data application.

12. The computer readable medium of claim 11, wherein the first instructions further cause the processor to perform the step of modifying the set of second instructions such that the set of second instructions are only able to create client health data applications.

13. The computer readable medium of claim 11, wherein the step of installing an application on a server computer includes creating a database.

14. The computer readable medium of claim 13, wherein the step of modifying the set of second instructions includes identifying the created database.

15. The computer readable medium of claim 11, wherein the step of installing an application on a server computer includes designating a database.

16. The computer readable medium of claim 11, wherein the step of modifying the set of second instructions to identify installation choices includes parsing an activation code.

17. The computer readable medium of claim 11, wherein the client health data application is configured to interface with a health management device.

18. The computer readable medium of claim 17, wherein the health management device includes a glucose measurement engine, and the client health data application is configured to receive and store data from the health management device.

19. A method of installing a client application including the steps of:
installing an application on a server computer including configuring the application;
copying an installer program to the server computer to create a replicated installer program;
incorporating configuration information regarding the configuration of the application installed on the server into the replicated installer program; and
executing the replicated installer program to create a client computer installation of the application that is configured according to the configuration information.

20. The method of claim 19, wherein the client computer installation of the application is a health data application configured to interface with a health management device including a glucose measurement engine.
